(19) United States
(12) Patent Application Publication
(10) Pub. No.: US 2023/0410219 A1
(43) Pub. Date: Dec. 21, 2023

(54) Smart Payroll System, Method, and Computer Program Product

(71) Applicant: Vicoland GmbH, Frankfurt am Main (DE)

(72) Inventors: Javier Diaz Jimenez, Andalucia (ES); Alexander McCullagh, Darmstadt (DE); Enrique Leon-Prado, Coripe (ES); Andreas Habsburg-Lothringen, Frankfurt am Main (DE)

(73) Assignee: Vicoland GmbH, Frankfurt am Main (DE)

(21) Appl. No.: 18/336,988

(22) Filed: Jun. 17, 2023

Related U.S. Application Data
(60) Provisional application No. 63/353,629, filed on Jun. 19, 2022.

(51) Int. Cl. G06Q 40/12; G06Q 20/08; G06Q 20/10

(52) U.S. Cl. CPC G06Q 40/125; G06Q 20/0855; G06Q 20/108; G06Q 30/04

(57) ABSTRACT

A networked computer system, method, and software for an online work platform with a trusted independent payment system that allows a client to hire a contractor online, who subsequently breaks a job into multiple tasks that can be performed by different subcontractors, also hired online. The client is only billed for each task, not for each subcontractor; and the work platform computes and adds in all taxes and fees. Once all of the subcontractors that are assigned to a task submit their work, it must be approved by the contractor and then the client before the client is billed in one invoice for all of the work performed. The client can pay via credit/debit card, or via an escrow account, to a trusted third-party financial services system, which then automatedly and concurrently pays the associated fees, e.g., taxes, the online work platform fee, the contractor fee, and each freelancer fee.

### CROSS-REFERENCE TO RELATED APPLICATION

This application claims the benefit of U.S. Provisional Application No. 63/353,629, filed 19 Jun. 2022, the disclosure of which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to generally to online work platforms comprising networked computer systems, methods, and computer program products that facilitate clients hiring online contractors, who subsequently hire online one or more subcontractors, all of whom are paid concurrently via an independent banking platform that also pays the associated taxes.

### BACKGROUND OF THE INVENTION

There are a multitude of online work platforms that allow a client to hire a contractor to perform work that can be done remotely (e.g., computer programming), and the contractor can subcontract to hire one or more subcontractors (e.g., freelancers) to perform one or more of the milestones required in the contract. The client will pay the online work platform, which will subsequently pay the contractor, who subsequently pays the subcontractors (i.e., freelancer(s)). The contractors and subcontractors pay a system fee (e.g., a cut of about 5-9% of their revenue) to the online work platform.

Disadvantages of these platforms are, e.g.: 1) the requirement for contractors to separately pay their subcontractors (i.e. freelancers) after s/he is paid by the client; and/or 2) requiring the contractor and each freelancer to pay their own sales and/or VAT taxes to the proper authority (tax office); and/or 3) the work platform not paying the contractor and freelancers at all, or in a timely manner. For (1), this may require using another payment platform than the online work platform; or requiring the contractor to open a separate job on the platform to pay their subcontractors. It also may result in the subcontractor not getting paid at all, or in a timely manner. For (2), this may result in the contractor and/or subcontractor miscomputing how much to pay for their sales and VAT taxes, or not paying at all or to the correct office. For (3), if the work platform is running a fraudulent operation, or files for bankruptcy, the client, contractor and subcontractors may have little recourse in recovering their payments.

Therefore, there is a need within the online work industry for a trusted networked computer system that automatedly and concurrently pays directly to each party: the online work platform fee, the contractor's and their subcontractor's fee, and any associated fees (e.g., taxes, licensing fees, etc.). The payments should be made by an independent third party (e.g., a verified financial services platform), which also pays the VAT and state income taxes and fees directly to the appropriate government agencies. Thus, the online work platform will preferably never need to handle payments to the contractor or subcontractor(s), and the taxes.

### SUMMARY OF THE INVENTION

Various embodiments of the present invention comprise a networked computer system, method, and software for an online work platform with a trusted independent payment system that allows a client to hire a contractor online, who subsequently breaks a job into multiple tasks that can be performed by different subcontractors, also hired online. The client is only billed for each task, not for each subcontractor; and the work platform computes and adds in all taxes and fees. Once all or substantially all of the subcontractors that are assigned to a task submit their work, it must be approved by the contractor and then the client before the client is billed in one invoice, preferably, for all of the work performed. The client can pay via credit/debit card, or via an escrow account, to a trusted third-party financial services system, which then automatedly and concurrently pays the associated fees, e.g., taxes, the online work platform fee, the contractor fee, and each freelancer fee.

In an exemplary embodiment, a work contract is broken into multiple tasks that are assigned to different freelancers who are working remotely, but the client is only billed for each task or milestone, not for each freelancer. For example, a client executes a contract with the contractor via the network in which the sales tax and VAT fees are added in. The contractor subdivides the contract into sequential tasks (e.g., milestones), wherein each milestone may be assigned to a plurality of freelancers to complete a part of the milestone within their area of expertise. Once all of the freelancers that are assigned to a milestone submit their work, it must be approved by the contractor and then the client; and, before the client is billed in one invoice for the work of all the freelancers and the contractor. The client can pay via credit/debit card, or via an escrow account. For either method, a trusted third-party financial services system holds their funds in escrow, or processes the credit/debit card payment. The online work platform does not have direct access to the client payments. The third-party system then automatedly, and concurrently pays the sales tax and the VAT fee, and pays the contractor and each freelancer for the task or milestone once the client has accepted the work.

The present invention comprises a networked computer method, system, and computer program product for concurrently paying contractors and freelancers fees, and associated fees on a project in a virtual office system, comprising:
a) a client hiring a contractor via an online work platform for a project, and the contractor breaking the project into one or more milestones, and hiring one or more freelancers to complete each milestone;
b) one or more freelancers submitting work, via the online work platform, to the contractor for one milestone of a project, and a freelancer invoice for each of the one or more freelancers;
c) the contractor reviewing and accepting each of the one or more freelancers' work, or returning via the network for correction;
d) once the contractor accepts each or all of the one or more freelancers' work, then the contractor submitting the work and a contractor invoice to a client via the network;
e) once a client approves all of the one or more freelancers' work, then the client submitting payment to a third-party payment system; and
f) the third-party payment system automatedly, directly, and concurrently paying the contract invoice, and the one or more freelancer invoices, and a system fee; and
g) repeating steps (b) through (f) for each milestone or task in the project.

Various embodiments of the present disclosure further comprise a networked computer method for concurrently paying, via an independent trusted third-party system, contractor and freelancers fees, and associated fees on a project in an online work platform, comprising:
a) receiving input from a client computer over a network, to hire a contractor via an online work platform for a project, and the receiving input from a contractor computer to break the project into one or more milestones, and hiring one or more freelancers to complete each milestone;
b) receiving input from one or more freelancer computers, to submit work, via the online work platform, to the contractor computer for one milestone of the project, and a freelancer invoice for each of the one or more freelancers;
c) receiving input from the contractor computer, for reviewing and accepting each of the one or more freelancer work, or returning via the network for correction;
d) receiving input on the client computer, for one contractor invoice for the milestone once the contractor accepts each or all of the one or more freelancers' work;
e) receiving input for payment from a client computer over the network, once a client approves all of the one or more freelancer work, and submits payment to a third-party payment system; and
f) the third-party payment system automatedly, directly, and concurrently paying the contract invoice, and the one or more freelancer invoices, and a system fee.

In an embodiment, the one or more freelancer's invoices each comprise a freelancer revenue, and a system fee comprising at least one of: Value-Added Tax (VAT), state sales tax, and third-party software licensing fees.

In an embodiment, the contractor's invoice comprises, e.g., one or more of: a) a sum of the one or more freelancer revenues; b) a contractor revenue; c) a contractor system fee; d) a sum of the system fee for the one or more freelancers; and e) wherein the system fees comprise at least one of: value-added tax (VAT); state sales tax; and third-party software licensing fees.

In an embodiment, the contractor submits to the client: 1) one-at-a-time of each freelancer's work of a plurality of freelancers assigned to a milestone, but only after the contractor approves each freelancer's work; or 2) all of the freelancers' work at one time after the contractor approves all of the freelancers' work.

In an embodiment, the contractor can subsequently break each milestone into one or more tasks, and hire one or more freelancers to complete each task.

In an embodiment, the client pays the contractor invoice via a debit or credit card payment to the third-party payment system; or via transferring funds to an escrow account on the third-party payment system.

In one or more embodiments, the third-party system transfers payment to the online work platform for the contractor system fee, and the one or more freelancer system fees, wherein the system fee comprises a set percentage (e.g., 3-9%) of the revenue earned by each worker (freelancer and contractor).

In one or more embodiments, the third-party system directly transfers the client payment to one or more freelancer's financial accounts and a contractor's financial account.

Advantages of the present invention comprise the following. First, automatic consolidation of the invoices of multiple independent individuals (freelancers) to the contractor into a single invoice, thus minimizing overhead on the client side (virtual office platform). The contractor then submits the single invoice to the client.

Second, the present invention allows employment of a persistent escrow account for all payments via the platform-independent of users, which allows clients to always transfer to the same bank account of a third-party system (e.g., Truust™). Hence, clients do not need to set up a new third-party system account with the same bank information each time they hire a contractor.

Third, automatic re-distribution of funds received by a general contractor to his subcontractors (freelancers), thus preventing contractors from not paying their freelancers.

Fourth, automatic calculation and invoicing by the networked computer system to the client of funds due to the contractor, and at least one freelancer for a milestone.

Fifth, automatic calculation and payment by the third-party financial system of fees due by the contractor and each freelancer to the appropriate agency, e.g., international VAT/Sales tax aggregation for two-level international setups.

Other objectives and advantages of the present invention are disclosed herein.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention, and should not be construed to limit the invention.

FIG. 1A is a computer flowchart of prior art steps in a client paying a contractor on the system, and the contractor then paying the freelancer on the system, or via another third-party system.

FIG. 1B is a computer flowchart for the primary method steps of smart payrolling of the present invention, illustrated as a UML diagram, demonstrating that the contractor and freelancer are paid concurrently, automatedly via an independent third-party financial system.

FIG. 1C is an exemplary block diagram of the networked computer system of FIG. 1B for use in the methods of the present invention.

FIG. 2 is a screenshot of the computer program product of the present invention for a freelancer to verify their required VAT, or sales tax rate, net and gross billing amount before submitting their completed work for a milestone to the contractor via the network.

FIG. 3 is a screenshot of the computer program product of the present invention for a contractor to verify their and the freelancers' required VAT, or sales tax rate, and the sum of the net and gross amount, before submitting the completed work for a milestone to the client computer via the network.

FIG. 4A is an illustration of an exemplary embodiment of split payments where for one milestone in a project, the system concurrently pays three freelancers, the contractor, and the project fees, taxes.

FIG. 4B is another illustration of split payments using the third-party financial system, e.g., Truust™, with a webhook call to directly pay the freelancer(s) and contractors and taxes due.

FIG. 5 is an illustration of two methods of payment from the client: 1) debit/credit card to the third-party system; or 2) via an escrow account on the third-party system that holds the client's funds in the escrow for the payment of the one contract invoice.

FIG. 6 is an illustration of the system allowing different freelancers to be assigned to different milestones on the same project.

FIG. 7 is an illustration of the method of a contractor assigning a task or milestone to a freelancer, and when the freelancer submits their work, the system calculates the taxes due based on the freelancer's geographic location.

FIG. 8 is an illustration of the method of when a contractor submits the freelancer(s) work to the client for a milestone, and the system calculates the taxes due based on the contractor's geographic location.

FIG. 9 is an exemplary block diagram of the components within the client's, contractor's, and freelancers' computers (i.e., user electronic computing devices).

### DETAILED DESCRIPTION OF THE INVENTION

### Glossary of Terms

Reference will now be made in detail to specific embodiments of the invention. Examples of these embodiments are illustrated in the accompanying drawings. While the invention will be described in conjunction with specific embodiments, it will be understood that it is not intended to limit the invention to these embodiments. On the contrary, the invention is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Unless defined otherwise, all technical terms used herein have the same meanings as commonly understood by one of ordinary skill in the art to which the invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

As used herein, a “computer” refers to one or more apparatuses and/or one or more systems that are capable of accepting a structured input, processing the structured input according to prescribed rules, and producing results of the processing as output. Examples of a computer may include: a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet computer, a personal digital assistant (PDA), a portable or mobile telephone or other mobile computing device; and generally, any apparatus that may accept data, process data according to one or more stored software programs, generate results, and typically include input, output, storage, arithmetic, logic, and control units.

As used herein, a “computer system” may refer to a networked system having one or more computers, where each computer may include computer-readable medium embodying software to operate the computer or one or more of its components. Non-limiting examples of a computer system may include: a distributed computer system for processing information via computer systems linked by a network; and, two or more computer systems connected together via a network for transmitting and/or receiving information between the computer systems.

As used herein, the term “processor” and “central processing unit (CPU)” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” or “computer-readable storage medium or media” refers to any medium that participates in providing data (for example, instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, memory card, memory stick, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G-5G.

As used herein, the term “Application” and/or “Software” refer to all, or a portion, of a computer program or software code that carries out a specific function and may be used alone or combined with other programs. Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript, JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Application Interface” or “Application User Interface” refers to the image displayed on the user's interface of their electronic computing device. For example, the translator may view an application interface on their graphical user interface of their computer that displays unique identifiers in lieu of text.

As used herein, the term “Electronic Computing Device” refers to an end-user's and translator's computer with network connectivity (e.g. Internet) and with a user interface to view and interact with the application interface, such as a laptop, desktop, tablet, etc., as well as any device defined herein as a “computer”.

As used herein, the term “system” and “networked computer system” and “networked system” refer to all of the hardware and software components that are connected via a wired and/or wireless network (e.g. an internet) for carrying out the method steps of the present invention.

As used herein, the term “third-party payment system” refers to an independent platform that is licensed to handle financial payments directly to the financial accounts of the contractor, freelancers, and Vicoland™ platform bank accounts. Non-limiting examples are: Truust™, PayPal™.

As used herein, the term “freelancer” and “subcontractor” and “member” are interchangeable and describe a worker hired by a contractor to complete a specific task(s) within a milestone of a project, or the entire milestone, or the entire project.

Table 1 lists terms that are used in the exemplary embodiments disclosed herein.

TABLE 1

| Term | Definition |
|---|---|
| Vicoland System | Virtual company - a consortium of freelancers with Vico lead as general |
| Virtual Office System | contractor performing a project for client(s) |
| Vico | |
| Vico lead | Head of a Vico, responsible and general contractor of a Vico |
| Vico member | A freelancer part of the Vico generally executing tasks assigned by Vico lead, |
| | legally a subcontractor |
| Client | The main person responsible on the ordering company side, who can accept |
| | offers and deliverables |
| SOW | Statement of Work - A description of project's work requirements defining |
| | deliverables, timelines and pricing |
| Milestone | A deliverable as part of the SOW |
| Task | A task for Vico member, part of Milestone |
| Vicopay ™ | Proprietary Vicoland payment service handling all operations around payments |
| Truust ™ | Third party payment service Vicoland integrates. This third party has a banking |
| | licence and holds the actual money |
| VAT | A Value-Added Tax (VAT) is a consumption tax assessed on the value added in |
| | each production stage of a good or service. Every business along the value chain |
| | receives a tax credit for the VAT already paid. The end consumer does not, |
| | making it a tax on final consumption. |

### System Architecture

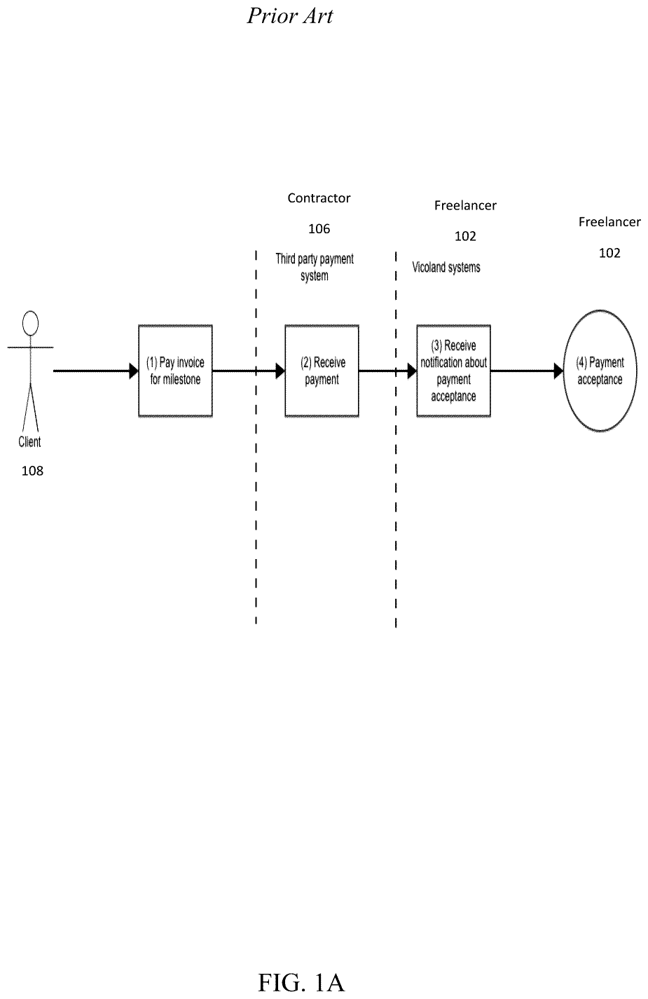

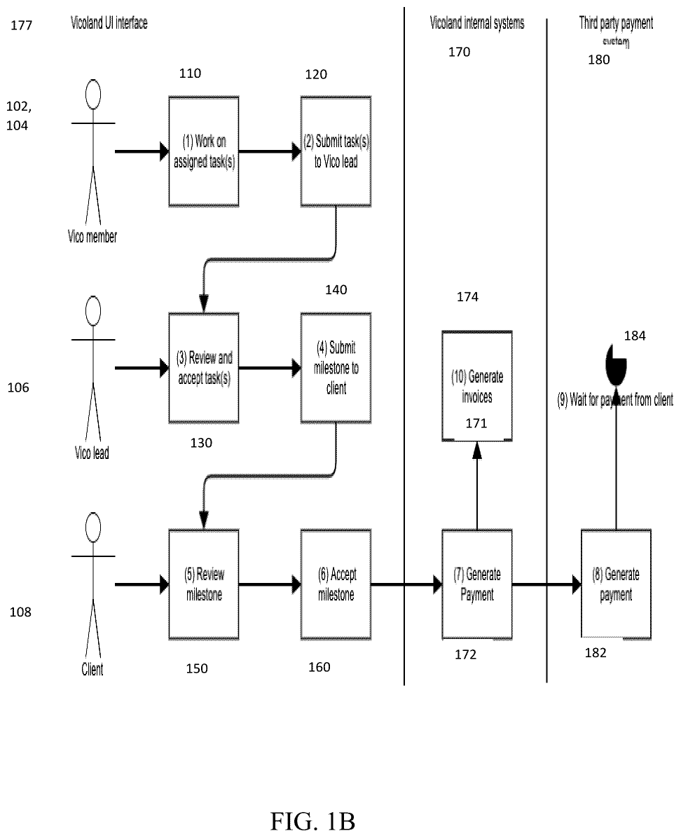

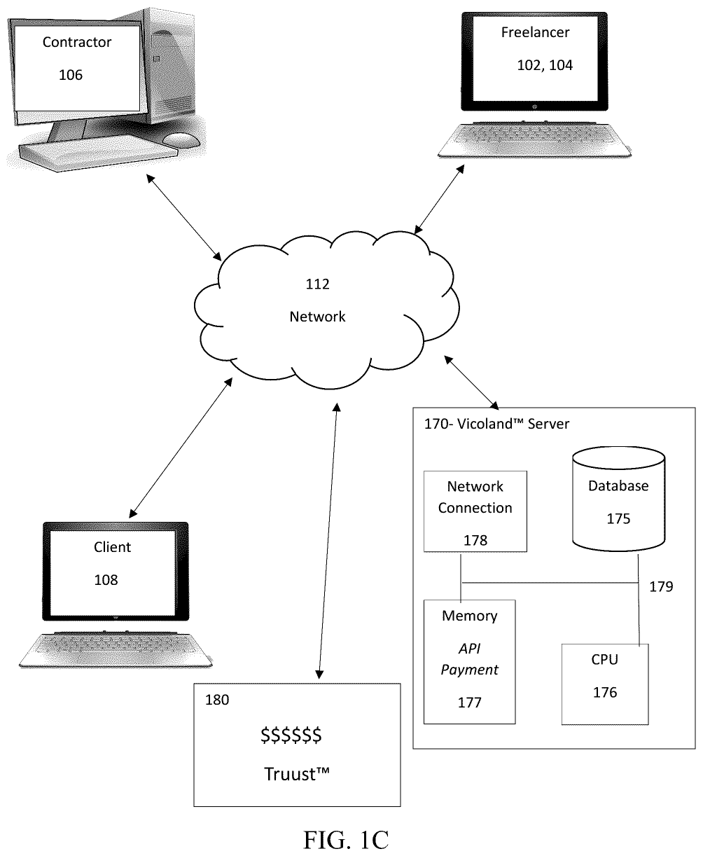

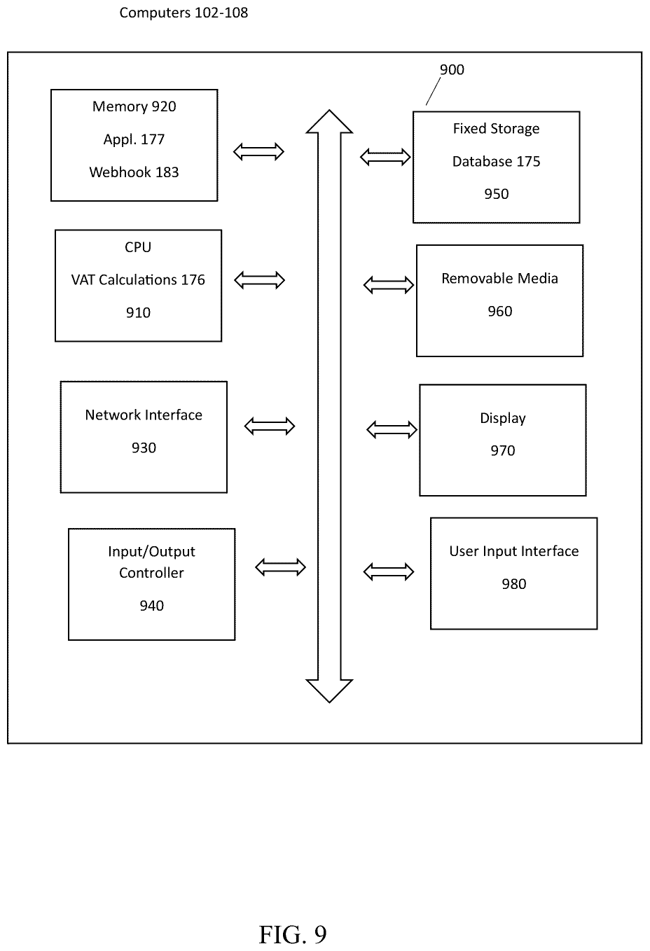

FIGS. 1B, 1C illustrate exemplary embodiments of the present invention comprising: a general flowchart or UML diagram for freelancers, a contractor, and a client to work together on one project (FIG. 1B); and a block diagram of the entire computer network using multiple user computing devices (FIG. 1C); and a block diagram of an exemplary client, contractor, and/or freelancer electronic computing device (FIG. 9). Embodiments of the presently disclosed subject matter may be implemented in and used with a variety of components and network architectures. In one or more embodiments, the system may comprise a Service-as-a-Software (SaaS) platform.

As illustrated in FIG. 1C, the system of the various embodiments may comprise, for example: one or more end-user electronic computing devices communicating via a network 112 (e.g. the Internet) with the Vicoland™ online work platform 170. For example, more user electronic computing devices (e.g. freelancers 102, 104; contractor 106; client 108 computers) are in communication with the Vicoland™ server 170 via the network 112.

The user electronic computing devices and Vicoland server 170 and the third-party financial system 180 may also communicate directly via the network 112, and/or with remote servers, databases, cloud computing services and the like. The system may also comprise a separate application server storing the end-user application 177 (e.g. cloud computing), or the application 177 may be stored on the end-user's device.

The network 112 may be a local network, wide-area network, the Internet, or any other suitable communication network or networks, and may be implemented on any suitable platform including wired and/or wireless networks. The electronic computing devices 102, 104, 106, 108 may connect to the network 112 via a variety of methods such as a phone modem, wireless (cellular, satellite, microwave, infrared, radio, etc.) network, Local Area Network (LAN), Wide Area Network (WAN), or any such means as necessary to communicate with the Vicoland platform server 170.

The network may also comprise various types of computer system configurations, including personal computers, hand-held devices, multi-processor systems, microprocessor-based or programmable consumer electronics, network PCs, minicomputers, mainframe computers, and the like. Where appropriate, embodiments may also be practiced in data centers, cloud computing environments, Software as a Service (SaaS) environments, or other distributed computing environments where tasks are performed by local and remote processing devices that are linked (either by hardwired links, wireless links, or by a combination thereof) through a communications network. In a distributed computing environment, program modules may be located in both local and remote memory storage devices.

Various embodiments of the presently disclosed subject matter may include or be embodied in the form of computer-implemented methods or processes and apparatuses for practicing those methods or processes; and/or, in the form of a computer program product having computer program code containing instructions embodied in non-transitory and/or tangible media, e.g., CD-ROMs, hard drives, USB (universal serial bus) drives, or any other machine readable storage medium, wherein, when the computer program code is loaded into and executed by a computer (e.g. device 102-108), the computer becomes an apparatus for practicing embodiments of the disclosed subject matter.

The various embodiments also may be embodied in the form of computer program code (e.g. Vicoland™ API for 177) or a mobile app associated with Vicoland server 170 or the third-party server 180. For example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer (e.g. devices 102-108), the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Lastly, the various embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

### General Method

FIG. 1A illustrates the prior art's problem that allows the contractor 106 to receive payment from the client 108, and then the contractor is responsible for paying the freelancers 102. If the contractor is negligent, or bankrupt, the freelancers may never be paid; but, the system of the present invention prevents this.

In FIG. 1B (see also FIG. 1C), step 110, the contractor computer 106 transmits (e.g. via the internet 112) to at least one member or freelancer computer (102, 104) an electronic message assigning a work task for completion of a project entered into via the client computer 108. The electronic message comprises a well-defined set of instructions and the monetary value that the client computer is billed upon successfully completion of the work task. Only one invoice is transmitted to the client computer for a completed work task (e.g. milestone) no matter how many freelancers were required to be hired for that work task.

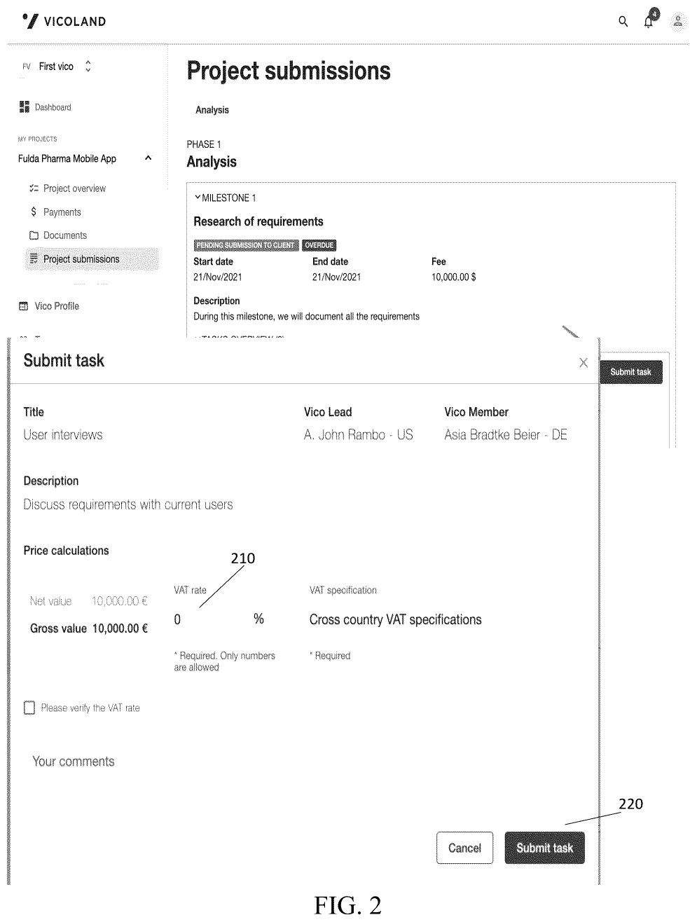

In step 120, the freelancer submits their work via their computer 102 to the contractor computer 106. FIG. 2 is a screenshot of an exemplary display for receiving freelancer input, wherein the system automatedly fills in the VAT and/or state sales tax rate 210 that applies to each freelancer based on their residency and/or geographic location. If the auto-fill is incorrect, the freelancer may manually correct it. By selecting the “Submit Task” button 220, the freelancer is indicating that they have reviewed and approved of the VAT, tax rate 210. The contractor can review the work product on their computer 106, and if they feel that it is not sufficient, they can transmit an electronic message to the freelancer regarding additional work needed. Once the contractor is satisfied, s/he selects an “Accept Task” button to notify the freelancer of work completion (step 130).

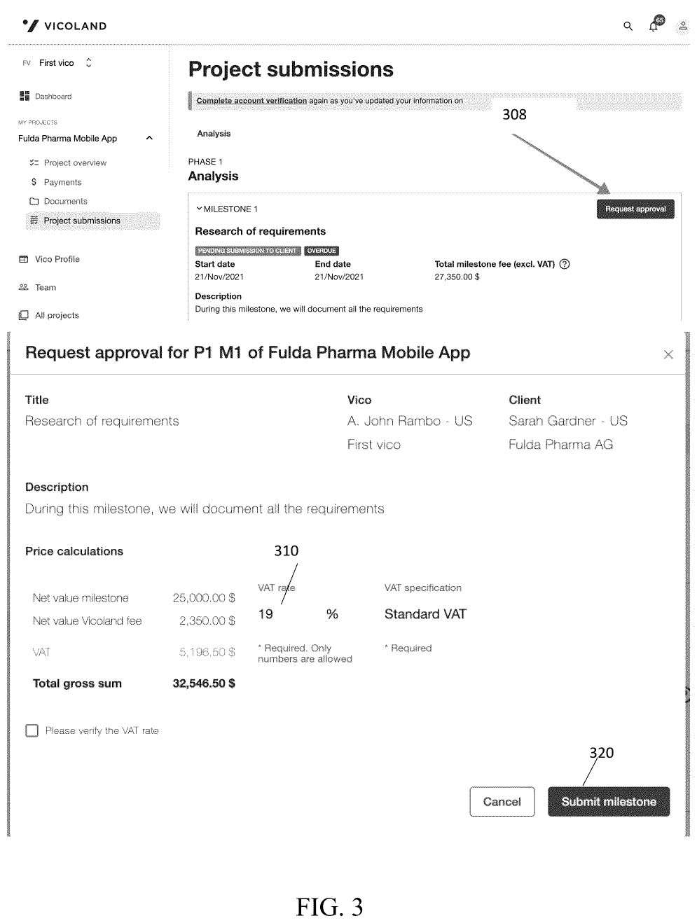

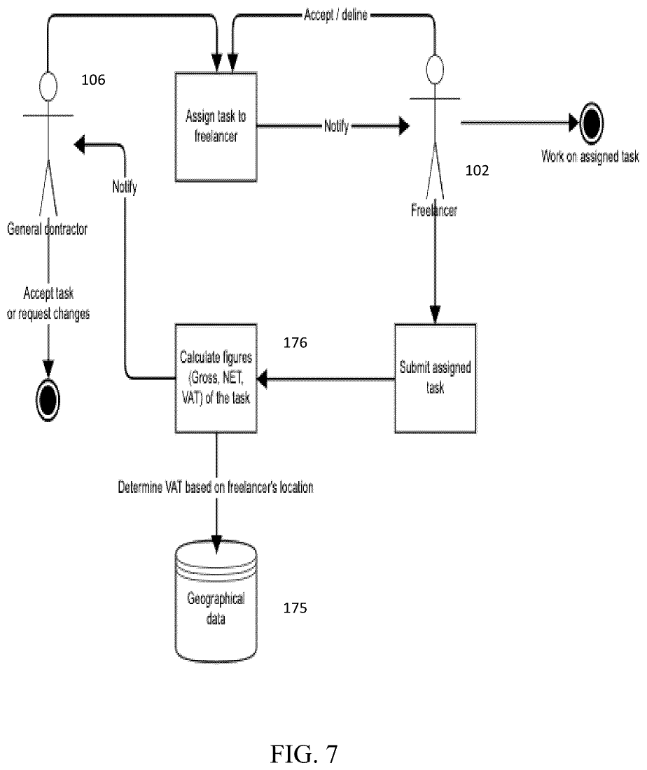

In step 140, the remote Vicoland™ system server 170 automatically monitors when the contractor has transmitted an “Accept Task” message to all of the freelancers that are assigned to a milestone or task. As illustrated in FIG. 3, only then will the system allow the contractor to select a “Request Approval” button 308 to the client, and verify the contractor's VAT and/or sales tax rate 310 by selecting “Submit Milestone” button 320. The plurality of freelancers' VAT and/or sales tax rate are included in the contractor's rate 310. (See also “Submit Tasks to Contractor” section infra, and FIG. 7).

In step 150, the client receives notification on their computer 108 that the contractor has submitted work and requested payment for a milestone. The client can review the work and request changes, which are transmitted to the contractor; or the client can accept the milestone (step 160).

In step 160, when the client selects the “Accept Milestone” button, s/he is verifying that the final work product meets their satisfaction, and that the displayed amount for the net value, the gross value billed, and the VAT amount are correct. The contractor is also checking a box stating that s/he understands one invoice will be sent to them for this gross value amount.

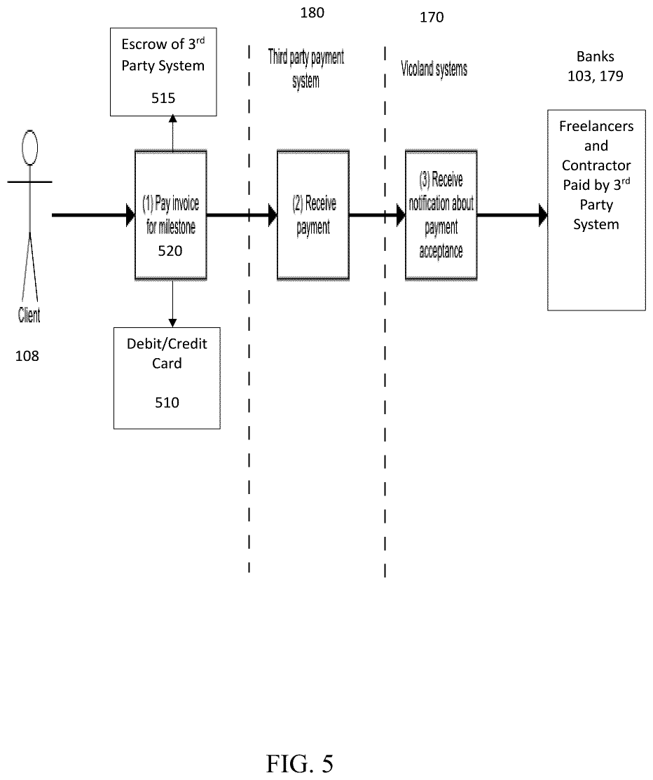

In step 172, system 170 will assign a unique reference number 171 to the client invoice, and then immediately, and automatedly generate and transmit this invoice to the client computer 108. The client may then pay the invoice by: 1) directly to Vicoland™ system 170 via credit/debit card; or 2) via a third-party system 180 (see FIG. 5). In the later, an application program interface (API), such as Vicopay Service™, will transmit a message to a third-party payment system (e.g. Truust™ 180) with the invoice to prepare for payment from the client's financial account (e.g. bank) to the third-party. The third-party system possesses a banking license, and it is regulated by the Foreign Currency Evaluations (FCE) for handling e-money.

In step 174, Vicoland system 170 also prepares invoices from each of the freelancers for this milestone to the contractor. The contractor and freelancers will be paid concurrently—per step 184.

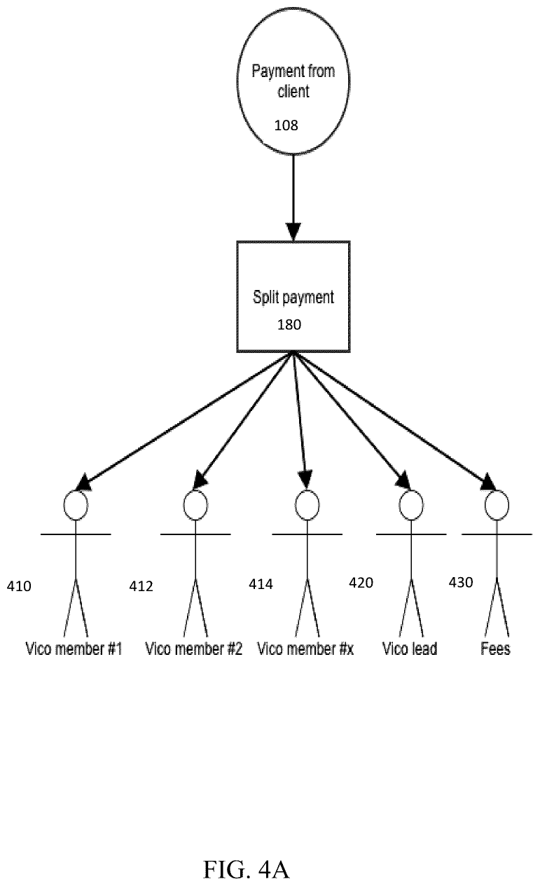

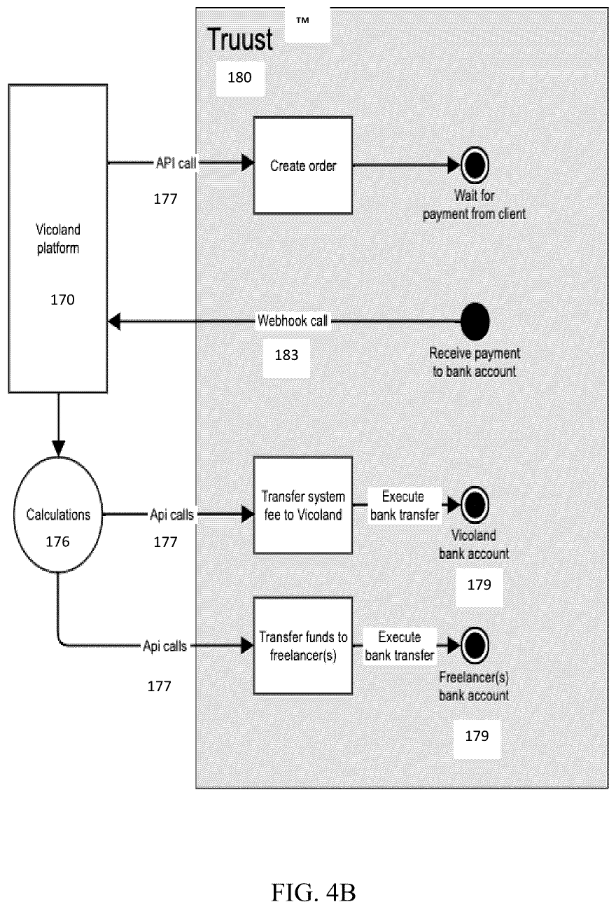

In step 182, the third-party system is monitoring for payment from the client. Once it arrives, it transmits a message (webhook call 183, FIG. 4B) to Vicoland™ system 170. This webhook 183 is a unique URL in the Vicoland system, which is called by the third-party system when there are changes in regards of payments initiated from the Vicoland system. For example, the Truust™ system calls Vicoland webhook when it finished executing a payment to contractor's bank account. Based on this webhook, the Vicoland system 170 updates all necessary information in the Vicoland database to reflect that the contractor payment was successfully finished, and sends an electronic notification to contractor. (See also FIG. 4B). In step 184, Vicoland™ system 170 waits for notification of payment from the client to the third-party system 180. Once the client's payment is made, the funds are held in an escrow account on the third-party system 180.

### Split Payment

As illustrated in FIGS. 1C, 4A and 4B: the transfer of funds to each of the freelancers participating in a project is accomplished by calling a third-party payment system, e.g. Truust™. Truust system 180 notifies Vicoland system 170 (see FIG. 1C) when payment from the client for a project was received (a webhook call, FIG. 4B, 183 to Vicoland™ system). At that point, the Vicoland™ system's CPU 176 (FIG. 1C) calculates how much each freelancer and Vicoland fee should be paid.

The payment itself is then transferred to the contractor's and the freelancers' bank account 103 by calling an API call 177 to Truust system 170 (from previous provided pseudocode), the following is detailed process of function initiatePaymentToFreelancer(toPayAmount) (Table 2). The same process applies to pay the Vicoland F ee To Vicoland with a difference that Vicoland is the receiver. Table 2 is exemplary computer code for this tax.

```
TABLE 2
function initiatePaymentToFreelancer(toPayAmount):
  order = Truust.createOrder(freelancerData, toPayAmount) transfer =
  Truust.transferFundsToWallet(order)
  bankPayment = Truust.transferFundsFromWalletToBankAccount(transfer) success =
  Truust.verifyPayment(bankPayment)
end
```

Truust.createOrder (Table 2) initiates the process of transfer of money from the funds received from a client to a specific freelancer.

Truust.transferFundsToWallet (Table 2) executes the transfer of funds to Freelancer's e-wallet (still in the Truust system 170).

Truust.transferFundsFromWalletToBankAccount (Table 2) executes transfer of funds from Freelancer's e-wallet to the Freelancer's own bank account.

Truust.verifyPayment (Table 2) makes verification calls that the money was successfully sent to the Freelancer's bank account.

As illustrated in FIGS. 1B, 4B: the computer program product (API Payment—177 of FIG. 4B), of third-party system 180 transfers payment: 1) directly from the client's escrow account to the freelancers' and contractor's bank account 103 (e.g. see FIG. 4B). Concurrently, the third-party system 180 will immediately pay the VAT and/or sales tax due (if any) directly from the client's invoiced amount to the appropriate government agency for each contract and freelancer. No client money is transferred to the Vicoland™ online work platform 170 except for system fees, e.g., the share of revenue from freelancers and contractor, software licensing fees, etc. In another embodiment, the system fees are paid directly to the Vicoland system's bank account 179 (see FIG. 4B). In an embodiment, the third-party system 180 directly pays the taxes due (if any) by the Vicoland™ platform 170, or transfers the money to platform 170 for filing.

Alternatively, if the amount paid by the client to the third-party system 180 is not sufficient, the funds will be held in escrow until full payment is made, e.g., a Vicoland™ accountant can review the matter and notify the client of outstanding amounts due.

FIG. 4A is an illustration of an exemplary embodiment for payment in one milestone in a project; or in an alternative embodiment, when one payment is made for the project by adding all milestones together. The client computer 108 transmits payment to the third-party system 180. Then, the third-party system 180 concurrently pays three freelancers (members 410, 412, 414) and their contractor (lead 420) and project fees 430 (e.g. third-party fees, VAT fees, sales tax fees—for each freelancer and contractor). Vicoland™ server/system 170 (see FIG. 1C) is notified via a webhook when these payments were made so that it can: 1) tell the third-party system how much to pay the contractor and freelancer(s); and/or 2) send an electronic communication to notify the contractor and freelancers of the payments; and/or 3) adjust balances due in their accounts to zero. Table 3 illustrates exemplary computer code for a webhook.

TABLE 3

```
acceptWebhookCallThatClientPaidInvoice( );
foreach freelancer:
  toPayAmount = sumAllTasksAssignedToFreelancer( );
  toPayAmount = adjustAmountByVATRate( )
    initiatePaymentToFreelancer(toPayAmount);
end
payVicolandFeeToVicoland( );
```

When the client is paying via credit/debit card, this payment occurs after the client approves all work performed. When the client is paying via escrow, the contractor may require that the funds be placed in escrow on the third-party system 180 before the work starts, or after the client approves all work performed. FIG. 5 is an illustration of the two methods of payment from the client: 1) debit/credit card 510 to the third-party system 180, which immediately, automatedly pays via the workers (contractor and freelancer(s)) and the system fees (3-9% of total revenue to workers paid to system 170); or 2) via route 515 wherein the third-party system 180 holds the client's funds in escrow for the payment of the one invoice once all the work is approved for a milestone or the entire project. As per FIGS. 4B and 5, Vicoland system 170 does not receive the actual payments to the freelancers, contractors, or their taxes, VATS. Only the notification of payment 520 is sent to system 170; while payments are made directly from the third-party system 180 to the bank accounts 103.

If the client uses route 2, they create an escrow account on the third-party system, which can be used repeatedly with different Vicoland system projects, contractors, etc.

In an alternative embodiment, in lieu of the client paying the contractor after each milestone, the project may be created to pay at the end of the project when all milestones are successfully completed. Table 4 is exemplary computer code for this situation.

TABLE 4

```
projectPrice = 0;
foreach projectMilestone:
  milestonePrice = 0;
  foreach milestoneTask:
    milestonePrice = milestonePrice + taskPrice;
  end
  projectPrice = projectPrice + milestonePrice;
end
projectPriceWithFee = projectPrice + (projectPrice *
vicolandFee)
projectPriceWithFeeAndVat = projectPriceWithFee +
(projectPriceWithFee * vatRate)
generateInvoice( );
sendInvoiceToClient( );
```

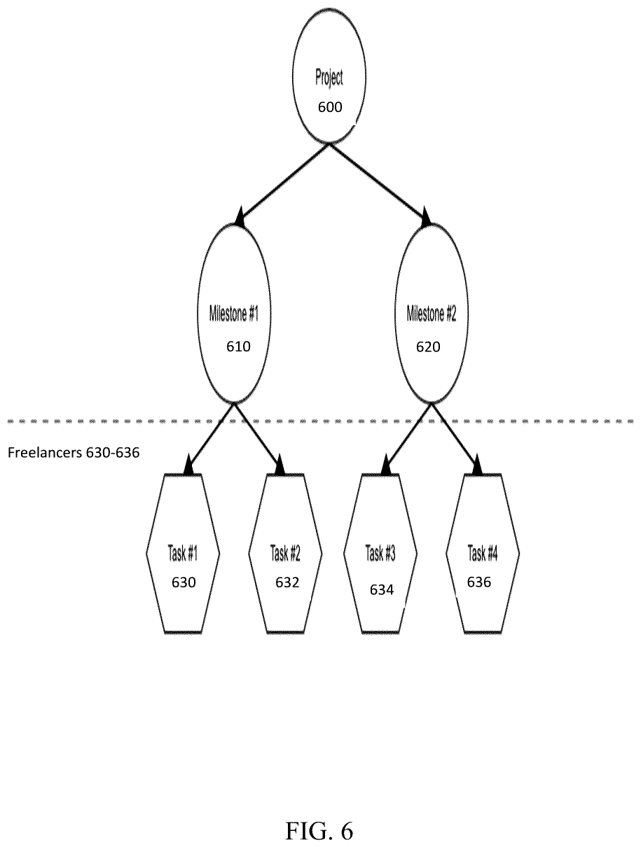

FIG. 6 is an illustration of the system allowing different freelancers (630, 632, 634, 636) to be assigned to different milestones on the same project. Each freelancer may have a specialty that is required in one task of a first milestone 610, but not in the second milestone 620. Thus, a contractor can arrange to hire a group of unique freelancers for each phase (e.g., task 1-4) of a project before committing to a client.

Method to Submit Tasks to Contractor from Freelancer

FIG. 7 is an illustration of the method of a contractor assigning a task or milestone to a freelancer, and when the freelancer submits their work, the system calculates the taxes due based on the freelancer's geographic location.

The contractor computer 106 receives contractor input to assign a task or milestone to a freelancer, who may accept or decline it. A freelancer submits their work via their computer 102 to the contractor via the Vicoland system, at which time the Vicoland CPU 176 computes the gross and net amounts due to the freelancer, and the VAT/taxes due based on the geographic location of the freelancer, which is stored in Vicoland's database 175 (see FIG. 1C).

Method to Submit Milestone to Client from Contractor

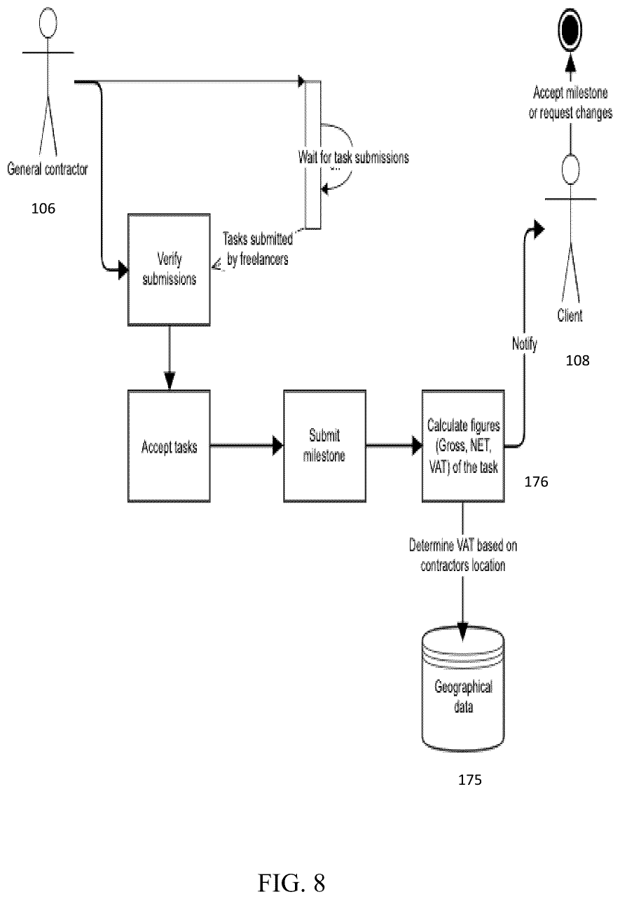

FIG. 8 is an illustration of the method of when a contractor submits the freelancer(s) work to the client for a milestone, and the system calculates the taxes due based on the contractor's geographic location.

The contractor computer 106 receives work submissions from a freelancer computer 102 via Vicoland system 170 (see FIG. 1C). If the work meets all expectations, the contractor computer 106 transmits it to the client computer 108 via the Vicoland system 170. At that time, the Vicoland CPU 176 computes the gross and net amounts due to the contractor, and the VAT/taxes due based on the geographic location of the contractor that is stored in Vicoland's database 175 (see FIG. 1C).

### Client, Contractor, Freelancer Computer

As illustrated in FIG. 9, the end-users' electronic computing device (FIG. 1C, 102-108) comprises, e.g.: an internal bus 900 connecting the major components of each device to its central processing unit (i.e. processor or microprocessor) 910 and memory 920. Devices 102-108 have the ability to transmit and receive electronic communications via a network interface 912 which allows the devices and servers to communicate with each other via one or more local, wide-area, or other networks. Furthermore, devices 102-108 may comprise any one of the following operating systems (OS), for example: Android or Windows or Apple, such as smartphones, tablets, laptops, desktops, etc.

The network interface 930 may provide a direct connection to a remote server (e.g. Application Server 177 and/or Third-party server 180) via an internet service provider (ISP), or a direct connection to a remote server via a direct network link to the Internet via a POP (point of presence) or other technique. The network interface 930 may connect the computers using wireless techniques, including digital cellular telephone connection, Cellular Digital Packet Data (CDPD) connection, digital satellite data connection or the like.

Memory 920 comprises read-only memory (ROM) or flash memory containing Basic Input-Output system (BIOS) controlling basic hardware operation including interaction with peripheral components. Memory 920 further comprises random access memory (RAM) comprising the main memory into which the device's operating system (e.g. Android or Windows or Apple), and application programs (e.g. Mobile apps for 177, 180) are loaded. The application programs can be stored on and accessed via a non-transitory computer readable medium, such as a hard disk drive (e.g., fixed storage 260), an optical drive, floppy disk, or other storage medium.

Bus 900 further connects an input/output controller 940, a user display 970, such as a display screen via a display adapter, a user input interface 980, which may include one or more controllers and associated user input devices such as a keyboard, mouse, touchscreen and the like, a fixed storage 950 (such as a hard drive, flash storage, Fiber Channel network, SAN device, SCSI device, and the like), and a removable media component 960 operative to control and receive an optical disk, flash drive, and the like. The fixed storage 950 may be integral with the device 102-108 or it may be separate and accessed through other interfaces. Computer program code to implement the various embodiments can be stored in computer-readable storage media such as one or more of the memory 920, fixed storage 950, removable media 960, or on a remote storage location.

The user input interface 980 enables a user to enter data and/or instructions to the device 102-108 through one or more corresponding input devices, such as an image scanner w/camera, a touch screen, a keyboard, a mouse, a trackball, a light pen, stylus, or other pointing device, a microphone, a joystick, a game pad, a satellite dish, a scanner, a camcorder, a digital camera, and the like. Similarly, examples of input interfaces 980 that may be used to connect the input devices to the bus 900 include a serial port, a parallel port, a game port, a universal serial bus (“USB”), a firewire (IEEE 1394), or another interface. Lastly, output interfaces connect one or more corresponding output devices to the bus 900, such as a monitor or display screen 970, a speaker, a printer, and the like. An output device can integrated with or peripheral to device, such as a video adapter, an audio adapter, a parallel port, and the like.

### CONCLUSION

The aforementioned UML diagrams illustrate the architecture, functionality, and operation of possible implementations of systems, methods, and apparatuses comprising computer program products (aka computer code) and/or computer-usable medium having computer-readable program code stored thereon according to various embodiments of the present invention. In this regard, a step(s) in the UML diagrams may represent a module, segment, or portion of code, which comprises one or more executable instructions for implementing the specified logical function(s).

It should also be noted that, in some alternative implementations, the functions noted in the diagrams may occur out of the order noted in the figures. For example, steps shown in succession may, in fact, be executed substantially concurrently, or the steps may sometimes be executed in the reverse order, depending upon the functionality involved. It will also be noted that each step of the UML diagrams, and combinations of steps, can be implemented by special purpose hardware-based systems that perform the specified functions or acts, or combinations of special purpose hardware and computer instructions.

And, in the above description, an embodiment is an example or implementation of the inventions. The various appearances of “one embodiment,” “an embodiment” or “some embodiments” do not necessarily all refer to the same embodiments.

The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Unless specifically stated otherwise, and as may be apparent from the description and claims herein, terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

As used herein, the term “substantially” refers to about or at 100%; and the term “about” refers to 5-10%, or 0-5% the stated amount.

The various embodiments may also be implemented in an operating environment comprising computer-executable instructions (for example, software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages.

Trademarks: The product names used in this document are for identification purposes only. All trademarks and registered trademarks are the property of their respective owners.

What is claimed is:

1. A networked computer method for concurrently paying, via an independent trusted third-party system, contractor and freelancers fees, and associated fees on a project in an online work platform, comprising:
a) receiving input from a client computer over a network, to hire a contractor via an online work platform for a project, and the receiving input from a contractor computer to divide the project into one or more milestones, and hiring one or more freelancers to complete each milestone;
b) receiving input from one or more freelancer computers, to submit work, via the online work platform, to the contractor computer for one milestone of the project, and a freelancer invoice for each of the one or more freelancers;
c) receiving input from the contractor computer, for reviewing and accepting each of the one or more freelancer work, or returning via the network for correction;
d) receiving input on the client computer, for one contractor invoice for the milestone once the contractor accepts substantially all of the one or more freelancer work;
e) receiving input for payment from a client computer over the network, once a client approves all of the one or more freelancer work, and submits payment to a third-party payment system; and
f) the third-party payment system automatedly, directly, and concurrently paying the contractor invoice, and the one or more freelancer invoices, and a system fee.

2. The networked computer method of claim 1, wherein one or more freelancer invoices each comprise a freelancer revenue, and a system fee comprising at least one of: Value-Added Tax (VAT); state sales tax; an online system platform fee; and third-party software licensing fees.

3. The networked computer method of claim 1, wherein the contractor invoice comprises:
a) a sum of the one or more freelancer revenues;
b) a contractor revenue;
c) a contractor online system platform fee; and
d) a sum of the online system platform fee for the one or more freelancers.

4. The networked computer method of claim 1, wherein the contractor computer transmits to the client computer via the network:
1) one-at-a-time of each freelancer's work of a plurality of freelancers assigned to a milestone after the contractor approves the freelancer work; or
2) all of the freelancers work at one time after the contractor approves all of the freelancers work.

5. The networked computer method of claim 1, further comprising receiving input from a contractor computer to subsequently break each milestone into one or more tasks, and hire one or more freelancers to complete each task.

6. The networked computer method of claim 1, wherein the client computer receives input to transmit payment via the network to the third-party payment system for the contractor invoice via a debit or credit card payment.

7. The networked computer method of claim 1, wherein the client computer receives input to transmit and deposit money in an escrow account on the third-party payment system to pay the contractor invoice.

8. The networked computer method of claim 7, wherein the third-party system transfers payment to the online work platform for the contractor system fee, and the one or more freelancer system fees.

9. The networked computer method of claim 8, wherein the third-party system directly transfers the client payment to one or more freelancer financial accounts and a contractor financial account.

10. The networked computer method of claim 1, repeating steps (b) through (f) for each milestone or task in the project.

11. A networked system, for concurrently paying contractors and freelancers on a project in a virtual office system, comprising:
a remote system server (170) connected via a network (112) to a plurality of user computers comprising: one or more remote freelancer computers (102, 104); a contractor computer (106); and a client computer (108);
the remote system server (170) comprising: at least one central processing unit; a memory storing a payment application program interface (API); a network connection; a database of user files; and a computer-readable storage medium having instructions stored which, when executed by the processor, cause the processor to perform operations comprising:
a) receiving input from a client computer over a network, to hire a contractor via an online work platform for a project, and the receiving input from a contractor computer to break the project into one or more milestones, and hiring one or more freelancers to complete each milestone;
b) receiving input from one or more freelancer computers, to submit work, via the online work platform, to the contractor computer for one milestone of the project, and a freelancer invoice for each of the one or more freelancers;
c) receiving input from the contractor computer, for reviewing and accepting each of the one or more freelancer work, or returning via the network for correction;
d) receiving input on the client computer, for one contractor invoice for the milestone once the contractor accepts all of the one or more freelancer work;
e) receiving input for payment from a client computer over the network, once a client approves all of the one or more freelancer work, and submits payment to a third-party payment system; and
f) the third-party payment system automatedly, directly, and concurrently paying the contractor invoice, and the one or more freelancer invoices, and a system fee.

12. The networked system of claim 11, wherein one or more freelancer invoices each comprise a freelancer revenue, and a system fee comprising at least one of: Value-Added Tax (VAT), state sales tax, and third-party software licensing fees.

13. The networked system of claim 11, wherein the contractor invoice comprises:
a) a sum of the one or more freelancer revenues;
b) a contractor revenue;
c) a contractor online system platform fee; and
d) a sum of the online system platform fee for the one or more freelancers.

14. The networked system of claim 11, wherein the client computer receives input to transmit payment via the network to the third-party payment system for the one contractor invoice via: 1) a debit or credit card payment; or, 2) an escrow account on the third-party payment system.

15. The networked system of claim 11, wherein the third-party system directly transfers the client payment to one or more freelancer financial accounts and a contractor financial account.

16. A non-transitory computer readable storage medium having instructions stored which, when executed by a computing device, cause the computing device to perform operations comprising:
a) receiving input from a client computer over a network, to hire a contractor via an online work platform for a project, and the receiving input from a contractor computer to break the project into one or more milestones, and hiring one or more freelancers to complete each milestone;
b) receiving input from one or more freelancer computers, to submit work, via the online work platform, to the contractor computer for one milestone of the project, and a freelancer invoice for each of the one or more freelancers;
c) receiving input from the contractor computer, for reviewing and accepting each of the one or more freelancer work, or returning via the network for correction;
d) receiving input on the client computer, for one contractor invoice for the milestone once the contractor accepts all of the one or more freelancer work;
e) receiving input for payment from a client computer over the network, once a client approves all of the one or more freelancer work, and submits payment to a third-party payment system; and
f) the third-party payment system automatedly, directly, and concurrently paying the contractor invoice, and the one or more freelancer invoices, and a system fee.

17. The non-transitory computer readable storage medium of claim 16, wherein one or more freelancer invoices each comprise a freelancer revenue, and a system fee comprising at least one of: Value-Added Tax (VAT), state sales tax, and third-party software licensing fees.

18. The non-transitory computer readable storage medium of claim 16, wherein the contractor invoice comprises:
a) a sum of the one or more freelancer revenues;
b) a contractor revenue;
c) a contractor online system platform fee; and
d) a sum of the online system platform fee for the one or more freelancers.

19. The non-transitory computer readable storage medium of claim 16, wherein the client computer receives input to transmit payment via the network to the third-party payment system for the one contractor invoice via: 1) a debit or credit card payment; or, 2) an escrow account on the third-party payment system.

20. The non-transitory computer readable storage medium of claim 16, wherein the third-party system directly transfers the client payment to one or more freelancer financial accounts and a contractor financial account.
